(19) United States
(12) Patent Application Publication
(10) Pub. No.: US 2006/0086344 A1
(43) Pub. Date: Apr. 27, 2006

(54) Device for an internal combustion engine

(76) Inventor: Karl-Gunnar Karlsson, Skovde (SE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/540,915

(22) PCT Filed: Dec. 29, 2003
(86) PCT No.: PCT/SE03/02078

§ 371 Date: Oct. 6, 2005

(30) Foreign Application Priority Data
Jan. 2, 2003 (SE) 0300004-9

(51) Int. Cl. F02M 25/06

(52) U.S. Cl. 123/573

(57) ABSTRACT

In an internal combustion engine, contaminated air in the crankcase creates problems. As a rule, the contaminated air is led into the engine's inlet manifold, and this can disrupt the smooth running of the engine. The invention eliminates the problem by having a filter connected to the crankcase, such that contaminated air from the crankcase must pass through this filter, where it is freed of its contaminants.

The present invention is for use with an internal combustion engine. In such engines, the air in the crankcase builds up a certain overpressure and must be released. However, release may not be in any way whatsoever. The air must first be cleaned. Up until now, cleaning has been by attempting to combust the contaminated crankcase air after it has been led from the crankcase back into the engine's inlet manifold. However, this has had certain disadvantages for the engine. Carbon coating is one example of such a disadvantage.

The purpose of the present invention is to eliminate these disadvantages by connecting a filter unit to the crankcase. The air from the crankcase has to pass through this filter unit, which separates contaminants from the air. The air thus cleaned by the filter unit is fed into, for example, the engine's inlet manifold. The undesirable particles filtered from the crankcase air can be led back to the crankcase. It is, of course, also possible to further filter the particles so that carbon particles and oil are separated. In this way, carbon particles could be separated and only the oil returned to the crankcase. In passing through the filter, it is possible for individual carbon particles to fuse into larger particles that are easily separated. Various types of filter can be used in the filter unit. It has, however, proven particularly advantageous to have fibre mats for the filter walls, the diameter of the fibres in the walls varying between 1 and 40 μm. The fibres may be thermally bonded to each other or bonded by needling. A particularly suitable construction of the filter is for it to have a body with a top face and a bottom face. The body is suitably positioned more or less vertical, or at a certain angle, to the internal combustion engine. In the vertical position, it is appropriate for air from the crankcase to be fed into the top of the body and for the body to house vertical walls of a fibrous mass, through which the air has to pass transversally. Cleaned air can then be taken from the top of the body. Under the influence of gravity, the separated particles fall to the bottom of the body. At the bottom of the body, there is a drainage opening. As a rule, this is connected to the crankcase. When this facilitates the separated particles falling to the bottom, it has proven advantageous to have the body at an angle to the internal combustion engine. The circumference of the body can have any shape whatsoever. It has proven that it can be practical for the body to have a quadratic cross section or an entirely circular cross section.

Further characteristics of the present invention are detailed in the following patent claims.

The present invention is more closely described in the following examination of the attached drawings where:

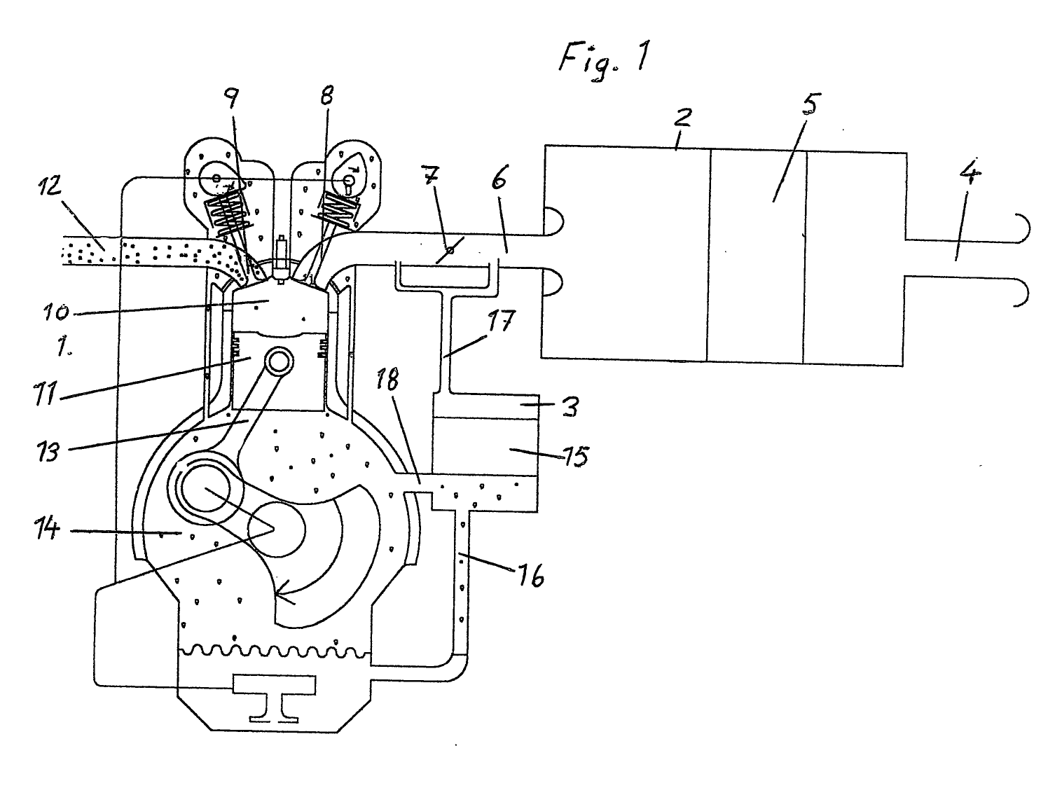

FIG. 1 shows an internal combustion engine with its associated filter and air intake,

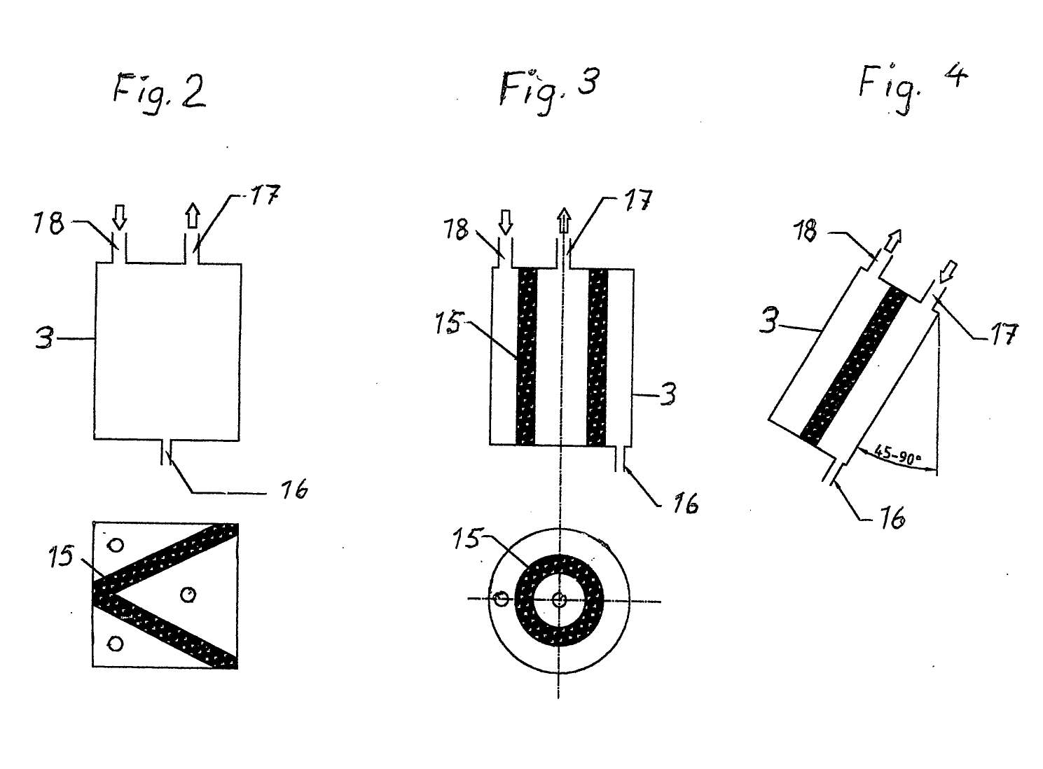

FIGS. 2 and 3 show two different models of a filter unit as per the present invention,

FIG. 4 shows an inclined filter unit.

FIG. 1 shows an internal combustion engine (1) with the thereto attached air intake (2) and a filter unit (3). The air intake has a passage (4) for outside air. This air has to pass through a filter (5) and is then fed into an inlet manifold (6). This has a damper (7). The inlet manifold (6) leads to a valve (8) on the engine's combustion chamber (10). Said combustion chamber has a further valve (9). A piston (11) operates inside the combustion chamber (10), which has an exhaust port (12). The piston (11) works in conjunction with a connecting rod (13) that operates inside a crankcase (14). As a rule, this contains oil. When the engine is running, contaminated air builds up to a high pressure in the crankcase. This air is evacuated, via a duct (18), to the filter unit (3). The filter unit (3) holds a filter cartridge (15), through which the air from the crankcase has to pass. Particles that have been filtered off are led away, through a conduit (16), to the crankcase. The cleaned air is led into the inlet manifold (6).

From this description of an internal combustion engine with the filter unit, it is clear that the contaminated air is completely cleaned by passage through the filter unit (3) and that, via a conduit (16), all the contaminants are led back into the crankcase.

FIGS. 2 and 3 each show a filter unit design that has proven particularly advantageous for internal combustion engines.

FIG. 2 shows a filter unit seen from the side (top illustration) and from the top (bottom illustration). The filter unit has a parallelepipedic body. Contaminated air enters the filter unit (3) via a conduit (18). Cleaned air is evacuated from the filter (3) via another conduit (17). There is a drainage conduit (16) at the bottom of the filter unit (3). There are two walls (15) of fibrous material in the parallelepipedic cavity. These walls run from the top to the bottom of the body. Looking at the bottom illustration in FIG. 2, it is clear that the contaminated air enters at one side of the two depicted filter walls (15) and that the contaminated air has to pass transversally through both filter walls (15). Cleaned air exits the filter unit via conduit 17 on the other side of the two filter walls. Contaminants are led away through drainage conduit 16.

In FIG. 3, the body is cylindrical. It has a cylindrical filter wall (15) running between the top and the bottom of the body. Here, the contaminated air has to pass transversally through the cylindrical filter (15). Cleaned air is led off from the inside of this cylindrical filter (15). The contaminants are led away through drainage conduit 16.

It has proven particularly appropriate to have both the described filter unit models (FIGS. 2 and 3) positioned at an angle to the engine block. This has the advantage that it makes it easier for the contaminants separated from the air to reach the bottom of the filter unit.

In the same way, it has proven particularly appropriate in the foregoing for the filter unit to have fibre mats in which the fibres can have a diameter between 1 and 40 μm. Said fibres can be bonded to each other by, for example, needling or thermal bonding.

To have the desired effect, the fibrous material used can, of course, be arranged in a number of different ways.

It should also be obvious that the cleaning of contaminated air can occur in other situations similar to that arising in an internal combustion engine.

1. Combustion engine device for lowering the pressure of the air that builds up in the crankcase when the engine is running, and for separating undesired particles from said air, a filter unit being connected with its inlet to the crankcase, the filter unit delivering clean air at its outlet, this air being, preferentially, led to the engine's inlet manifold and the separated particles being led back into the crankcase, the whole being characterised by:
the container having, running between its ends, one or more walls or cylinders of a fibrous nature, the contaminated air having to pass through these walls/cylinders, the fibres being needled.

2. Device as per patent claim 1,
characterised by the container having a fixed position in relation to the internal combustion engine.

3. Device as per patent claim 1,
characterised by the container having a predetermined angle in relation to the internal combustion engine.

4. Device as per patent claim 1,
characterised by each wall/cylinder being comprised of fibre mats, in which the. fibres have a diameter in the range 1-40 μm.
